(19) United States
(12) Patent Application Publication
(10) Pub. No.: US 2024/0303911 A1
(43) Pub. Date: Sep. 12, 2024

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Hiroyasu ITO, Tokyo (JP)

(21) Appl. No.: 18/443,433

(22) Filed: Feb. 16, 2024

(30) Foreign Application Priority Data
Mar. 10, 2023 (JP) 2023-037503

(51) Int. Cl. G06T 15/20; G06T 15/50; G06T 19/20

(52) U.S. Cl. CPC G06T 15/20; G06T 15/50; G06T 19/20; G06T 2219/2012

(57) ABSTRACT

An image processing apparatus: obtains information on a brightness value of a captured image captured by an image capture apparatus for generating a foreground image or of a background image generated from the captured image; corrects color information of three-dimensional shape data of a background based on the brightness value; and generates a virtual viewpoint image by using the three-dimensional shape data colored with the corrected color information.

### BACKGROUND

### Field

The present disclosure relates to processing based on a captured image.

### Description of the Related Art

There exists a method of generating a virtual viewpoint image, which is an image from any viewpoint, by placing multiple image capture apparatuses at different positions and causing them to perform imaging from multiple viewpoints temporally in synchronization with one another, and using the images obtained by this imaging. The virtual viewpoint image allows a viewer to see a highlight play in a soccer game or a basketball game from various angles and can therefore provide the viewer with a high sense of presence as compared to an image obtained by imaging by an image capturing apparatus. To generate a virtual viewpoint image that provides a viewer with a high sense of presence, it is necessary to properly reproduce shadows.

Japanese Patent Laid-Open No. 2020-191598 discloses a method of generating a virtual viewpoint image in which shadows in the background are reproduced based on images captured by a first image capture apparatus for generating a foreground image and a second image capture apparatus with a wide angle of view for generating a background image.

Here, the method disclosed in Japanese Patent Laid-Open No. 2020-191598 requires the second image capture apparatus with a wide angle of view for generating a background image in addition to the first image capture apparatus for generating a foreground image. This increases burdens such as the cost and time for placing the second image capture apparatus. This accordingly increases the burden for generating a proper virtual viewpoint image in which shadows in the background are reproduced.

### SUMMARY

An image processing apparatus of the present disclosure: obtains information on a brightness value of captured image captured by an image capture apparatus for generating a foreground image or of a background image generated from the captured image; corrects color information of three-dimensional shape data of a background based on the brightness value; and generates a virtual viewpoint image by using the three-dimensional shape data colored with the corrected color information.

Further features of the present disclosure will become apparent from the following description of exemplary embodiments with reference to the attached drawings.

### BRIEF DESCRIPTION OF THE DRAWINGS

FIG. 1 is a diagram illustrating an example of a configuration of an image processing system;

FIG. 2 is a diagram for describing an example of the hardware configuration of an image processing apparatus;

FIG. 3 is a block diagram illustrating an example of the functional configurations of image capture processing apparatuses and the image processing apparatus;

FIG. 4 is diagram for describing brightness information of a background;

FIG. 5 is a flowchart describing a flow of a process of generating background brightness difference information;

FIG. 6 is a flowchart describing a flow of a process of generating a three-dimensional background model with shadows applied;

FIG. 7 is diagram for describing a merge process;

FIG. 8 is a block diagram illustrating an example of the functional configurations of image capture processing apparatuses and the image processing apparatus;

FIGS. 9A and 9B are diagrams illustrating an example of foreground information;

FIG. 10 is a flowchart describing a flow of a process of generating background brightness difference information; and

FIG. 11 is a block diagram illustrating an example of the functional configurations of image capture processing apparatuses and the image processing apparatus.

### DESCRIPTION OF THE EMBODIMENTS

Embodiments of the technology of the present disclosure will be described in detail below. Note that the components described in the following embodiments merely represent exemplary forms of the technology of the present disclosure and do not limit the scope of the technology of the present disclosure. Moreover, terms with reference signs differing only in the alphabetical letter suffixed to the number part represent different instances of an apparatus having the same function. In a case of referring to any of the apparatuses having the same function, the alphabetical letter in the reference sign may be omitted.

### First Embodiment

### [System Configuration]

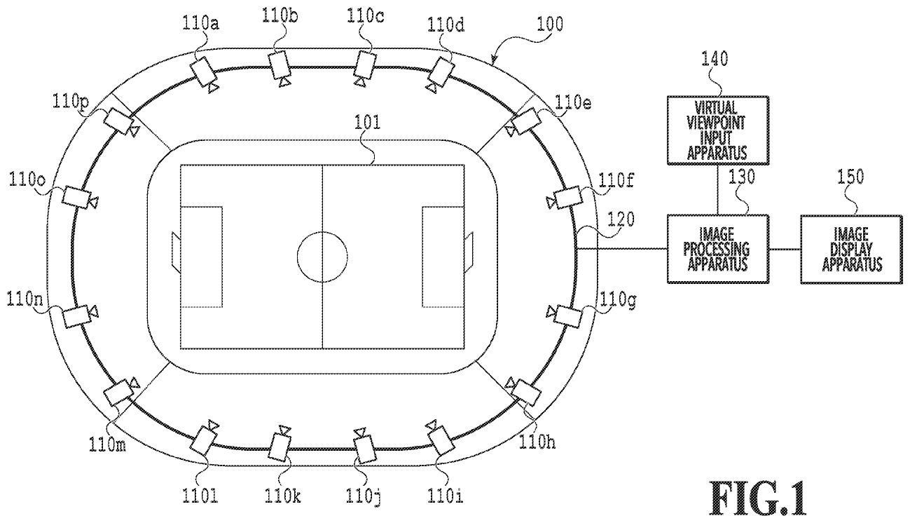

FIG. 1 is a diagram illustrating an example of the configuration of an image processing system in a first embodiment for generating a virtual viewpoint image. The image processing system has multiple image capture processing apparatuses 110a to 110p, an image processing apparatus 130, a virtual viewpoint input apparatus 140, and an image display apparatus 150.

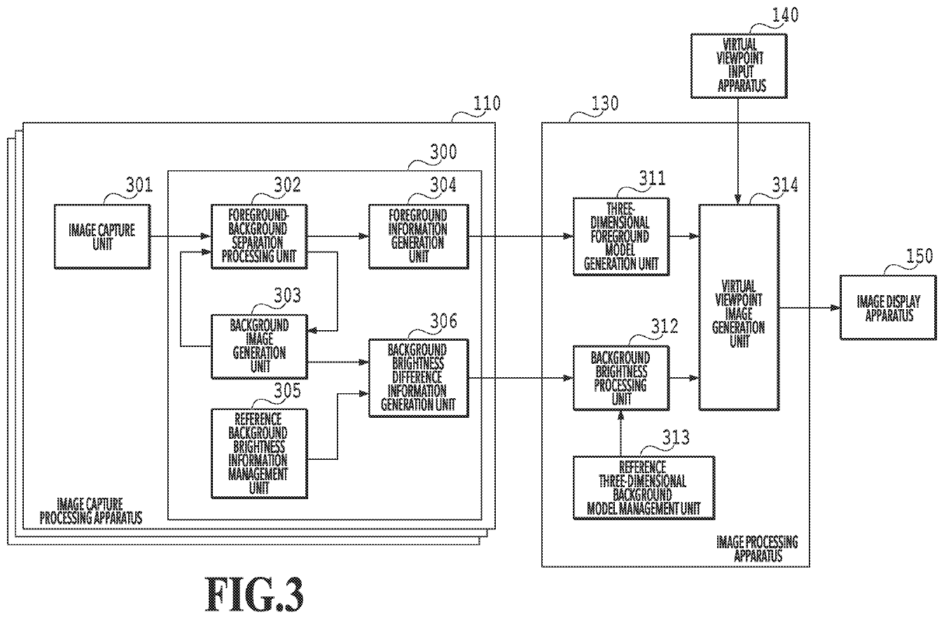

The virtual viewpoint image is an image representing a view from a virtual viewpoint which is different from the viewpoint of an actual image capture apparatus. The virtual viewpoint image in the present embodiment, which is also called a free viewpoint image, is not limited to an image from a viewpoint designated by the user freely (as desired). The virtual viewpoint image also includes, for example, an image from a viewpoint selected by the user from among multiple candidate viewpoints. Also, the present embodiment will be described on the assumption that the virtual viewpoint is designated by a user operation, but the virtual viewpoint may be automatically designated based on the result of an image analysis or the like. Moreover, the present embodiment will be described on the assumption that the virtual viewpoint image is a moving image, but the virtual viewpoint image may be a still image. Image capture units 301 (see FIG. 3) included respectively in the multiple image capture processing apparatuses 110a to 110p capture images of a region where an object is present (image capture region) from multiple viewpoints temporally in synchronization with one another. The virtual viewpoint image is generated by using multiple captured images thus obtained and information on a designated virtual viewpoint.

The multiple image capture processing apparatuses 110a to 110p are arranged such that their image capture units 301 can capture images of the image capture region from multiple positions. As illustrated in FIG. 1, the image capture region is a field 101 where sports, such as soccer and baseball, are played, for example. The image capture region may also be a stage in a venue where a concert or some other entertainment is performed. In order to capture images of such an image capture region, or the field 101, from multiple directions, the multiple image capture processing apparatuses 110a to 110p are placed at different positions so as to surround the field 101. Then, the image capture units 301 included in the image capture processing apparatuses 110a to 110p capture images of the field 101. Note that the number of the multiple image capture processing apparatuses 110a to 110p is not limited to the number illustrated in FIG. 1.

The image capture processing apparatuses 110a to 110p are connected to the image processing apparatus 130 by a network 120. The image processing apparatus 130 is an apparatus that generates a virtual viewpoint image. The virtual viewpoint input apparatus 140 is an apparatus that receives a virtual viewpoint designated by the user and outputs information on the received virtual viewpoint to the image processing apparatus 130. The image display apparatus 150 is an apparatus that displays the generated virtual viewpoint image. The image processing apparatus 130 is connected to the virtual viewpoint input apparatus 140 and the image display apparatus 150.

### [Hardware Configuration]

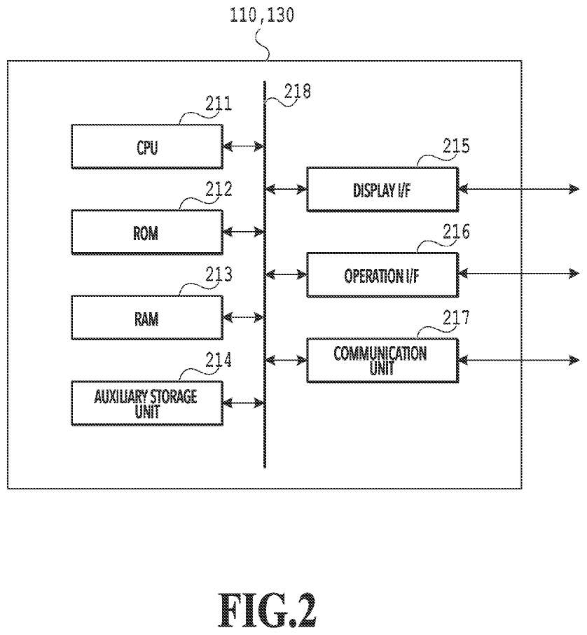

FIG. 2 is a diagram for describing an example of the hardware configuration of the image processing apparatus 130. The image processing apparatus 130 has a central processing unit (CPU) 211, a read-only memory (ROM) 212, a random-access memory (RAM) 213, an auxiliary storage unit 214, a display interface (I/F) 215, an operation I/F 216, a communication unit 217, and a bus 218. Note that the image capture processing apparatuses 110 have a hardware configuration similar to FIG. 2. The image processing apparatus 130 in the following description can be read as the image capture processing apparatuses 110. This may be considered a description of the hardware configuration of the image capture processing apparatuses 110.

The CPU 211 implements the functions of the image processing apparatus 130 by comprehensively controlling the image processing apparatus 130 with a computer program and data stored in the ROM 212 or the RAM 213. The image processing apparatus 130 may have one or more dedicated pieces of hardware other than the CPU 211, and at least part of processing by the CPU 211 may be executed by the dedicated pieces of hardware. Examples of the dedicated pieces of hardware include an application-specific integrated circuit (ASIC), a field-programmable gate array (FPGA), a digital signal processor (DSP), and so on. The ROM 212 stores programs requiring no change and the like. The RAM 213 temporarily stores programs and data supplied from the auxiliary storage unit 214, data externally supplied via the communication unit 217, and the like. The auxiliary storage unit 214 is, for example, a hard disk drive or the like and stores various pieces of data such as pieces of image data and audio data.

The display I/F 215 is an interface for connecting to a display unit such as a liquid crystal display or a light emitting diode (LED) display, for example. The CPU 211 displays a graphical user interface (GUI) for the user to give instructions to the image processing apparatus 130 on the display unit via the display I/F 215. In the case of the image processing apparatus 130, the image display apparatus 150 is connected to the display I/F 215 as the display unit, for example. The image display apparatus 150 displays a generated virtual viewpoint image.

The operation I/F 216 is an interface for connecting to an operation unit being an apparatus to be operated by the user such as button switches, a keyboard, a mouse, a joystick, and/or a touch panel, for example. In the case of the image processing apparatus 130, the virtual viewpoint input apparatus 140 is connected to the operation I/F 216 as the operation unit, and receives information on a virtual viewpoint from the virtual viewpoint input apparatus 140, for example. The CPU 211 operates as a display control unit that controls the display unit and as an operation control unit that controls the operation unit. The description will be given on the assumption that the operation unit and the display unit are present outside the image processing apparatus 130, but at least one of the operation unit or the display unit may be present inside the image processing apparatus 130.

The communication unit 217 is used for communication between the image processing apparatus 130 and external apparatuses. For example, in a case where the image processing apparatus 130 is wired-connected to an external apparatus, a communication cable is connected to the communication unit 217. In a case where the image processing apparatus 130 has a function of wirelessly communicating with an external apparatus, the communication unit 217 includes an antenna. The bus 218 connects the components of the image processing apparatus 130 and transfers information to and from them.

### [Functional Configuration of Image Capture Processing Apparatuses]

FIG. 3 is a block diagram illustrating an example of the functional configurations of the image capture processing apparatuses 110 and the image processing apparatus 130. First, the functional configuration of the image capture processing apparatuses 110 will be described. Each image capture processing apparatus 110 has an image capture unit 301 and an image processing unit 300.

The image capture unit 301 is an image capture apparatus, such as a digital video camera, for example, and has an interface for outputting image signals, such as a serial digital interface (SDI). The image capture unit 301 images an image capture target to obtain a captured image. The captured image obtained by the imaging by the image capture unit 301 is output to the image processing unit 300 via the image signal interface.

The image processing unit 300 has a foreground-background separation processing unit 302, a background image generation unit 303, a foreground information generation unit 304, a reference background brightness information management unit 305, and a background brightness difference information generation unit 306. The image processing unit 300 has an image processing apparatus' functions. Thus, the image capture processing apparatus 110 can be seen as an apparatus including an image processing apparatus.

The foreground-background separation processing unit 302 extracts a foreground region and a background region from the captured image obtained by the imaging by the image capture unit 301, and generates a foreground image by extracting the foreground region. The foreground-background separation processing unit 302 generates the foreground image by, for example, extracting, as a foreground region, a region in the captured image obtained by the imaging by the image capture unit 301 and a background image generated by the later-described background image generation unit 303 where the difference in pixel value between these two images is more than or equal to a predetermined value.

The foreground region refers to a region of a dynamic object (foreground) which moves (i.e., the position or shape changes) in a case where it is imaged from the same direction over time. Examples of the foreground object include persons such as players and referees on a field where a sport is played, a ball in a case where the sport is a ball sport, and so on. The examples also include singers, instrument players, other performers, and emcees in concerts and other entertainments, and so on.

The background region refers to a region of an image capture target which remains stationary or nearly stationary in a case where it is imaged from the same direction over time. Examples of such an image capture target include structures, fields, and the like such as a stadium where a sport is played, a venue where a concert is performed, goals used in a ball sport. In sum, the background region is a region in a captured image that is different from its foreground region. The foreground-background separation processing unit 302 outputs an image of the background region obtained by removing the foreground region from the captured image to the background image generation unit 303.

The background image generation unit 303 takes in images of the background region output from the foreground-background separation processing unit 302 in chronological order and performs a process of sequentially updating a background image, which is an image containing no foreground. Specifically, the background image generation unit 303 updates the pixel values of the region in the last generated background image extracted as the background region this time to the pixel values of the images of the background region output from the foreground-background separation processing unit 302. By updating the pixel values of the background region in a background image generated in advance in this manner, a new background image is generated. The background image generation unit 303 outputs the generated background image. As described above, an image generated by imaging by each of the image capture units 301 included in the image capture processing apparatuses 110a to 110p in the present embodiment is used to generate a foreground image. Moreover, a background image is updated based on the image obtained by the imaging by the image capture unit 301. Thus, in the present embodiment, the background image is generated from the captured image used for generating the foreground image. This eliminates the need to prepare an image capture apparatus for generating the background image.

The foreground information generation unit 304 generates foreground information from the foreground image generated by the foreground-background separation processing unit 302. The foreground information is information containing at least foreground textures and a foreground mask image indicating the foreground region.

The reference background brightness information management unit 305 stores and manages reference background brightness information, which is information on a brightness value serving as a reference for backgrounds in the image capture range (field of view) of the image capture unit 301, in a storage unit. This reference brightness value is a brightness value in a state with no shadow. In the present embodiment, a reference three-dimensional background model is generated in advance, which is a three-dimensional model of a background to be described later. The reference three-dimensional background model is colored in the state with no shadow in advance. The reference background brightness information is generated by, for example, converting the colors of a reference three-dimensional shape model in the image capture range of the image capture unit 301 into colors representing brightness.

The background brightness difference information generation unit 306 calculates the difference between the brightness value serving as a reference for backgrounds indicated by the reference background brightness information managed by the reference background brightness information management unit 305 and the brightness value of the background image output from the background image generation unit 303 on a pixel-by-pixel basis. The background brightness difference information generation unit 306 then generates background brightness difference information indicating the difference value of brightness of each pixel. Details will be described later. The background brightness difference information generation unit 306 also functions as an output unit and outputs the background brightness difference information to the image processing apparatus 130.

The image processing apparatus 130 has a three-dimensional foreground model generation unit 311, a background brightness processing unit 312, a reference three-dimensional background model management unit 313, and a virtual viewpoint image generation unit 314.

The three-dimensional foreground model generation unit 311 generates data of a three-dimensional model indicating the three-dimensional shape of the foreground (referred to also as “three-dimensional shape data”) by using the pieces of foreground information output from the foreground information generation units 304 of the image capture processing apparatuses 110a to 110p. The three-dimensional shape data of a foreground object will be referred to as “three-dimensional foreground model” or “foreground model.” The three-dimensional foreground model generation unit 311 generates the three-dimensional foreground model using the foreground mask images by visual hull, for example.

The reference three-dimensional background model management unit 313 stores and manages the reference three-dimensional background model, which is a three-dimensional model of a background generated in advance, in a storage unit. The reference three-dimensional background model is data representing the three-dimensional shape of a target object as a background such as a stadium 100 including the field 101. The three-dimensional model of the background will be referred to also as “three-dimensional background model” or “background model.” The reference three-dimensional background model is generated in advance by, for example, three-dimensionally measuring the stadium, venue, or the like that will be the background in advance and applying computer graphics, photogrammetry, or the like to the measurement result.

The reference three-dimensional background model in the present embodiment is colored in the state with no shadow in advance. As for the coloring method, in the case of using computer graphics, the reference three-dimensional background model is colored in colors designated by the creator of the reference three-dimensional background model. In the case of using photogrammetry, the reference three-dimensional background model is colored by collecting and mapping the background textures with no shadow. Color information of the reference three-dimensional background model is held as two-dimensional source textures to be attached to the three-dimensional model.

The background brightness processing unit 312 obtains the background brightness difference information output from the background brightness difference information generation unit 306. The background brightness processing unit 312 then applies the background brightness difference information to the color information of the reference three-dimensional background model to generate a three-dimensional background model on which light and shade (shadows) are applied. Details will be described later.

The virtual viewpoint image generation unit 314 generates a virtual viewpoint image based on a virtual viewpoint by using the three-dimensional foreground model generated by the three-dimensional foreground model generation unit 311 and the three-dimensional background model with shadows applied generated by the background brightness processing unit 312.

The functional units in the image processing unit 300 and the functional units in the image processing apparatus 130 in FIG. 3 are each implemented by the CPU of the corresponding apparatus executing a predetermined program, but the present embodiment is not limited to this manner. Alternatively, for example, hardware such as a graphics processing unit (GPU) for speeding up computation or an FPGA may be utilized. Each functional unit may be implemented by software and hardware, such as a dedicated integrated circuit (IC), cooperating with each other, or some or all of the functions may be implemented solely with hardware.

### [Reference Background Brightness Information and Brightness Difference Information]

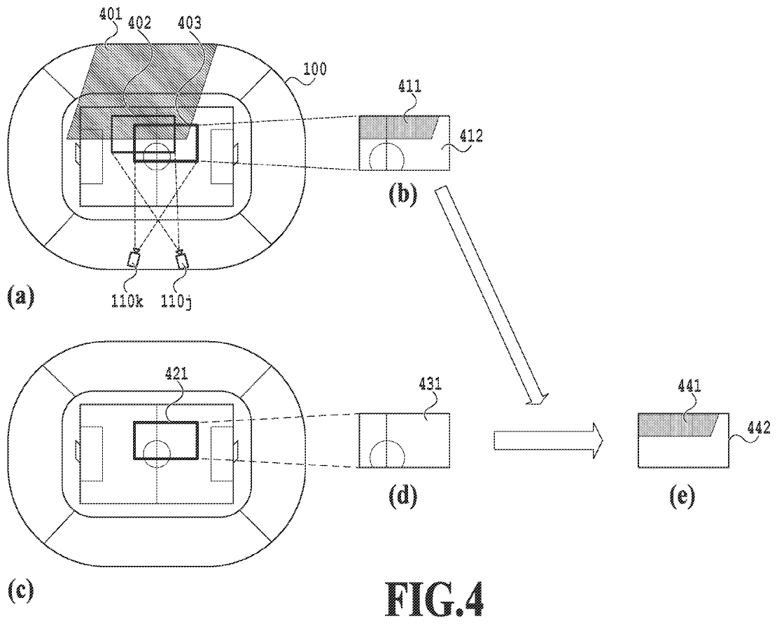

FIGS. 4 is diagrams for describing brightness information on the image capture range (field of view) of the image capture processing apparatus 110k. The reference background brightness information managed by the reference background brightness information management unit 305 of the image capture processing apparatus 110k will be described using FIG. 4. The generation of the background brightness difference information for a single frame by the background brightness difference information generation unit 306 of the image capture processing apparatus 110k will also be described.

In FIG. 4, the diagram (a) schematically showing an actual state of the stadium 100 in a case of capturing images including the field with the image capture units 301 of the image capture processing apparatuses 110a to 110p is illustrated. A hatched region 401 in the diagram (a) of FIG. 4 represents the shadow of a main stand roof of the stadium 100.

The bold frame in the diagram (a) of FIG. 4 represents an image capture range 403 of the image capture unit 301 included in the image capture processing apparatus 110k. An image capture range 402 is the image capture range of the image capture unit 301 of the image capture processing apparatus 110j, which overlaps the image capture range 403.

In FIG. 4, the diagram (b) showing “background brightness information” of a background image extracted from a captured image obtained by imaging by the image capture unit 301 included in the image capture processing apparatus 110k is illustrated. A gray region 411 in the diagram (b) of FIG. 4 represents a region corresponding to a shadow on the stadium 100 included in the image capture range 403. A region 412 excluding the region 411 represents a region other than the shadow included in the image capture range 403.

The background brightness information illustrated as the diagram (b) of FIG. 4 is an image obtained by converting the pixel value of each pixel in the background image into a brightness value. The brightness value is a gray value which is a color value on a grayscale, for example. For example, the background brightness information is an image obtained by converting the color value of each pixel in the background image, which is a color value in an RGB color space, into a gray value. Note that the brightness value is not limited to a gray value. The brightness value may alternatively be a value obtained by weighting a gray value.

Also, the brightness value of each pixel in the background brightness information is a value corrected such that the image capture condition is the same as a predetermined image capture condition. For example, it is a value corrected so as to be a value based on an image capture condition under which the exposure value (EV) is 12. The image capture condition under which the EV is 12 includes a case where ISO is 400, the f-stop number is 5.6, and the shutter speed is 1/500, and the like.

Assume that a value of “50” is equally obtained as the brightness values of the pixels in the shadow region 411 in the background image of the diagram (b) of FIG. 4. Also, the following description will be given on the assumption that a value of “120” is equally obtained as the brightness values in the region 412 in the background image.

In of FIG. 4, the diagram (c) showing the reference three-dimensional background model of the stadium 100 managed by the reference three-dimensional background model management unit 313 is illustrated. A region 421 is a region in the reference three-dimensional background model corresponding to the image capture range 403 of the image capture processing apparatus 110k.

In FIG. 4, a diagram (d) showing “reference background brightness information” corresponding to the image capture range 403 of the image capture processing apparatus 110k is illustrated. The reference background brightness information is an image representing the image capture range of the image capture unit 301 and holds brightness values in the state with no shadow as the pixel values of the pixels of the image. The reference three-dimensional background model is colored in the state with no shadow. Thus, the reference background brightness information can be obtained by converting the color values of the region 421 in the reference three-dimensional background model representing the image capture range of the image capture processing apparatus 110k into brightness values (e.g., gray values). In other words, the reference background brightness information of the image capture processing apparatus 110k is the brightness values of a region corresponding to the image capture range of the image capture unit 301 of the image capture processing apparatus 110k in the reference three-dimensional background model.

The following description will be continued on the assumption that the brightness value of each pixel held in the whole region 431 in the reference background brightness information illustrated as the diagram (d) of FIG. 4 is equally a value of “100” in a case where the EV is 12.

In FIG. 4, the diagram (e) is illustrated in which the pixel value of each pixel is the difference value between the pixel value of the pixel in the last background brightness information of the image capture processing apparatus 110k illustrated as the diagram (b) of FIG. 4 and the pixel value (brightness value) of the pixel in the reference background brightness information of the image capture processing apparatus 110k illustrated as the diagram (d) of FIG. 4. The diagram (e) of FIG. 4 will be referred to as “background brightness difference information.” In other words, the background brightness difference information represents an image in which the pixel value of each pixel is a background brightness difference value calculated as the difference value between the pixel value of the corresponding pixel in a background image whose pixel values have been converted into brightness values and the pixel value of the pixel in the reference background brightness information. The background brightness difference information of each of the image capture processing apparatuses 110a to 110p is generated in this manner in units of a predetermined number of frames.

The background brightness difference values being the pixel values of a region 441 in the background brightness difference information (the diagram (e)) in FIG. 4 are calculated by subtracting “100” being the pixel values of the region 431 in the reference background brightness information from “50” being the pixel values of the region 411 in the background brightness information, that is, 50−100=−50. The background brightness difference values being the pixel values of a region 442 are calculated by subtracting “100” being the pixel values of the region 431 in the reference background brightness information from “120” being the pixel values of the region 412 in the background brightness information, that is, “120−100=+20.” As a result, the background brightness difference information is generated as grayscale bitmap data corresponding to the background image with values ranging from −128 to +127 as pixel values (background brightness difference values).

### [Process of Generating Background Brightness Difference Information]

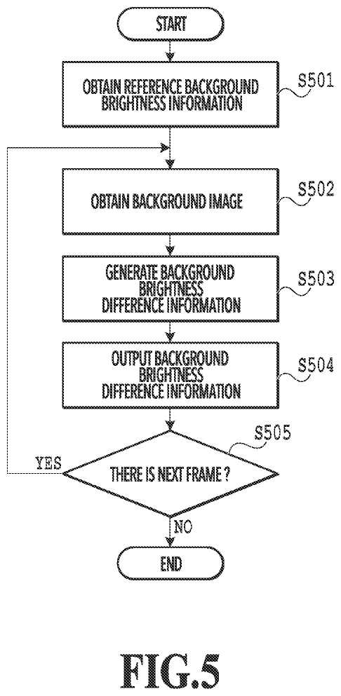

FIG. 5 is a flowchart describing a flow of a process of generating the background brightness difference information illustrated as the diagram (e) in Fig. E. The flowchart of FIG. 5 illustrates a process performed by one of the image capture processing apparatuses 110a to 110p. The image capture processing apparatuses 110a to 110p perform the flowchart of FIG. 5 in parallel with one another.

The CPU of each image capture processing apparatus 110 performs the series of processes illustrated in the flowchart of FIG. 5 by loading program code stored in the ROM to the RAM and executing it. Also, the functions of some or all of the steps in FIG. 5 may be implemented with hardware such as an ASIC or an electronic circuit. Meanwhile, the symbol “S” in the description of each process means a step in the flowchart. This applied also to the subsequent flowchart.

In S501, the background brightness difference information generation unit 306 reads out the reference background brightness information. For example, in a case where the image capture processing apparatus 110k is performing the flowchart of FIG. 5, the background brightness difference information generation unit 306 reads out the reference background brightness information illustrated as the diagram (d) in FIG. 4, which holds brightness values of the background in the state with no shadow. The processes of next S502 to S504 are processes for a processing target frame.

In S502, the background brightness difference information generation unit 306 reads out and obtains the background image updated by the background image generation unit 303 based on the captured image of the processing target frame.

In S503, the background brightness difference information generation unit 306 generates background brightness difference information. In S503, first, the background brightness difference information generation unit 306 converts the pixel value of each pixel in the background image obtained in S502 into a brightness value. The background brightness difference information generation unit 306 then corrects the brightness value obtained by the conversion such that the EV becomes the same as the reference EV. The background brightness difference information generation unit 306 generates new background brightness information in this manner. In the case where the image capture processing apparatus 110k is performing the flowchart of FIG. 5, the image illustrated as diagram (b) in FIG. 4 is generated as the background brightness information.

Then, the background brightness difference information generation unit 306 calculates background brightness difference values each being the difference between the brightness value of a pixel in the background brightness information and the brightness value of the pixel in the reference background brightness information obtained in S501, and generates background brightness difference information indicating the background brightness difference value of each pixel. For example, in the case where the image capture processing apparatus 110k is performing the flowchart of FIG. 5, the image illustrated in FIG. 4E is generated as the background brightness difference information.

In S504, the background brightness difference information generation unit 306 outputs the generated background brightness difference information to the image processing apparatus 130. As mentioned earlier, the image capture processing apparatuses 110a to 110p perform S502 and S503 for the processing target frame in parallel with one another. Accordingly, the image processing apparatus 130 receives the background brightness difference information of the processing target frame from each of the image capture processing apparatuses 110a to 110p.

In S505, the background brightness difference information generation unit 306 determines whether there is a next frame that needs to be processed. If determining that there is a next frame that needs to be processed (YES in S505), the background brightness difference information generation unit 306 returns to S502 in order to generate the next frame's background brightness difference information. In a case of generating a virtual viewpoint moving image, the processes of S502 to S504 in FIG. 5 are repeated to generate background brightness difference information for generating the virtual viewpoint moving image, which is formed of multiple frames. If determining that there is no next frame (NO in S505), the background brightness difference information generation unit 306 terminates the processing in this flowchart.

### [Flow of Process of Generating Three-Dimensional Background Model]

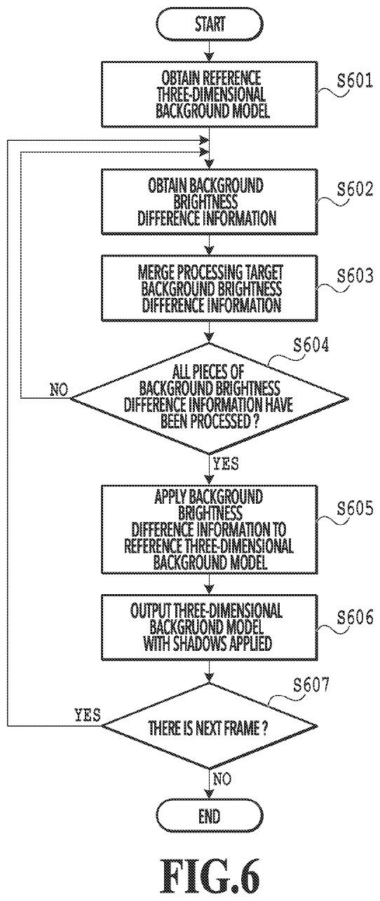

FIG. 6 is a flowchart describing a flow of a process of generating a three-dimensional background model with shadows applied. The CPU of the image processing apparatus 130 performs the series of processes illustrated in the flowchart of FIG. 6 by loading program code stored in the ROM to the RAM and executing it. Also, the functions of some or all of the steps in FIG. 6 may be implemented with hardware such as an ASIC or an electronic circuit.

In S601, the background brightness processing unit 312 reads out the reference three-dimensional background model. The processes of next S602 to S606 are performed on a frame-by-frame basis.

In S602, the background brightness processing unit 312 selects processing target background difference information from among the pieces of background brightness difference information of the processing target frame obtained from the image capture processing apparatuses 110a to 110p. Then, the background brightness processing unit 312 performs the process of S603 on the processing target background difference information. After finishing the process for the processing target background difference information, the background brightness processing unit 312 selects background difference information yet to be processed from among the pieces of background brightness difference information of the processing target frame obtained from the image capture processing apparatuses 110a to 110p again. The background brightness processing unit 312 proceeds to S605 if there is no more background difference information yet to be processed in S604.

In S603, the background brightness processing unit 312 performs a merge process on the processing target background brightness difference information. In the merge process, the background brightness processing unit 312 obtains the background difference information of the processing target frame generated from the image captured by the image capture unit 301 having an image capture range (field of view) overlapping the image capture range for the processing target background difference information. The background brightness processing unit 312 then synthesizes the processing target background brightness difference information and the obtained background brightness difference information to convert them into data of a region that needs to be applied to the reference three-dimensional background model.

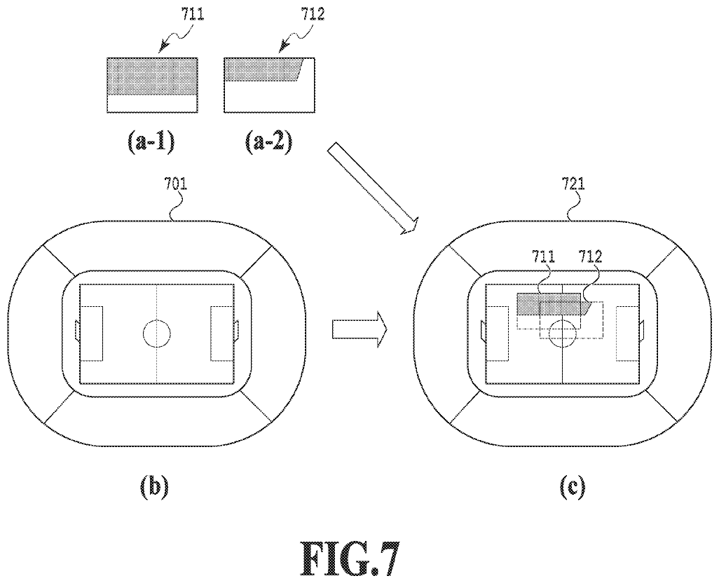

FIG. 7 is a diagram for describing the merge process. Background brightness difference information 712 illustrated as the diagram (a-2) of FIG. 7 is background brightness difference information output from the image capture processing apparatus 110k, and represents the processing target background brightness difference information. Background brightness difference information 711 illustrated as the diagram (a-1) of FIG. 7 is background brightness difference information output from the image capture processing apparatus 110j, and represents the background brightness difference information obtained for performing the merge process. Specifically, the background brightness difference information 711 represents background difference information having a portion where the image capture range overlaps that of the background brightness difference information 712.

In a case of synthesizing two pieces of background difference information, the pixels representing the same portion in their image capture ranges may have different pixel values (brightness values). For this reason, the pixel values of the pixels representing the same portion in the image capture ranges are normalized and used as the pixel values of the synthesized background brightness difference information. Performing the merge process normalizes the values of the overlapping portion and therefore prevents the brightness of the three-dimensional background model from appearing patchy.

In S604, the background brightness processing unit 312 determines whether the merge process has been finished for all pieces of background brightness difference information of the processing target frame output from the image capture processing apparatuses 110a to 110p. If determining that the process has not been finished for all pieces of background brightness difference information (NO in S604), the background brightness processing unit 312 brings the processing back to S602. The background brightness processing unit 312 then repeats S602 and S603 until the process is finished for all pieces of background brightness difference information.

If determining that the process has been finished for all pieces of background brightness difference information (YES in S604), the background brightness processing unit 312 advances the processing to S605. By completing the merge process for all pieces of background brightness difference information, a two-dimensional grayscale image with pixel values ranging from −128 to +127, which covers the whole stadium 100, is obtained as merged background brightness difference information.

In S605, the background brightness processing unit 312 applies the merged background brightness difference information to the color information of the reference three-dimensional background model to generate a three-dimensional background model colored such that the light and shade (shadows) at the time of capturing the processing target frame are applied. The diagram (b) of FIG. 7 shows a reference three-dimensional background model 701. The diagram (c) of FIG. 7 shows a state where the two merged pieces of background brightness difference information 711 and 712 have been applied to the reference three-dimensional background model 701.

Assuming, for example, that the reference three-dimensional background model has been colored with color values in an RGB color space, then, in S605, the color information of the reference three-dimensional background model is converted from the color values in the RGB color space into color values in a color space including luminance. Then, of the converted color values, the luminance values are increased or decreased by the background brightness difference values corresponding to the background brightness difference information. As a result, the background brightness difference information is applied to the color information of the reference three-dimensional background model. Also, assuming that the color information of the reference three-dimensional background model is held as two-dimensional textures, the merged background brightness difference information (two-dimensional grayscale image) is applied to the two-dimensional textures. As described above, background difference information is applied to the reference three-dimensional background model to generate a three-dimensional background model with shadows applied.

In S606, the background brightness processing unit 312 outputs the generated three-dimensional background model with the shadows in the processing target frame applied to the virtual viewpoint image generation unit 314.

The processes of S602 to S606 are repeated on a frame-by-frame basis. If determining in S607 that there is a next frame (YES in S607), the background brightness processing unit 312 brings the processing back to S602. If determining that there is no next frame (NO in S607), the background brightness processing unit 312 terminates the processing in this flowchart.

The virtual viewpoint image generation unit 314 in the present embodiment generates a virtual viewpoint image of the processing target frame by using the three-dimensional background model with the shadows applied and a three-dimensional foreground model. Specifically, the virtual viewpoint image generation unit 314 maps the foreground textures included in foreground information onto the three-dimensional foreground model. Then, the virtual viewpoint image generation unit 314 performs rendering on the colored three-dimensional foreground model and the colored three-dimensional background model with the shadows applied based on the virtual viewpoint of the processing target frame to thereby generate a virtual viewpoint image.

The above description has been given on the assumption that the process of applying the background brightness difference information of a processing target frame to the reference three-dimensional background model is performed on a frame-by-frame basis. Alternatively, a moving average of pieces of background brightness difference information of multiple frames may be calculated, and the resulting information may be applied to the reference three-dimensional background model across the multiple frames.

As described above, in accordance with the present embodiment, even in a case of generating a virtual viewpoint image by using a three-dimensional background model generated in advance by computer graphics or the like, it is possible to apply the actual brightness, the shadows of structures appearing in the background, and the like to the virtual viewpoint image. For example, the shadows of clouds suddenly appearing in a background generated by computer graphics or the like and so on can be added in real time. Accordingly, it is possible to generate a less unnatural virtual viewpoint image with a foreground and a background matching each other in brightness.

### Second Embodiment

In the first embodiment, a method of generating background brightness difference information by using a background image updated by the background image generation unit 303 has been described. In a second embodiment, a method of generating background brightness difference information by using a captured image output from the image capture unit 301 and a foreground mask image will be described.

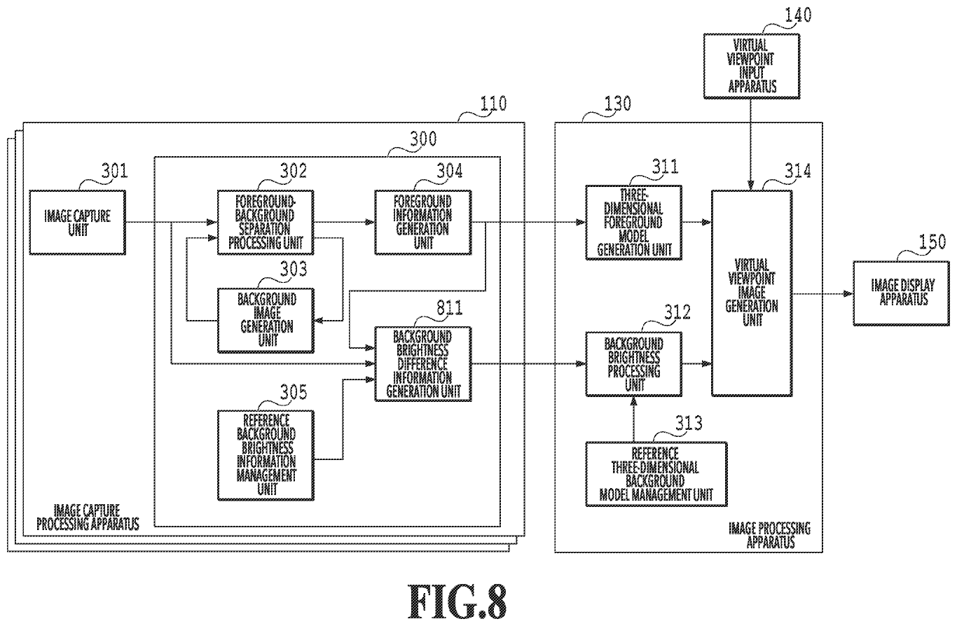

FIG. 8 is a block diagram illustrating a functional configuration of image capture processing apparatuses 110 in the present embodiment. Functional units similar to those in the first embodiment are denoted by the same reference signs, and description thereof is omitted. A background brightness difference information generation unit 811 generates background brightness difference information by using reference background brightness information output from the reference background brightness information management unit 305, a captured image output from the image capture unit 301, and a foreground mask image output from the foreground information generation unit 304.

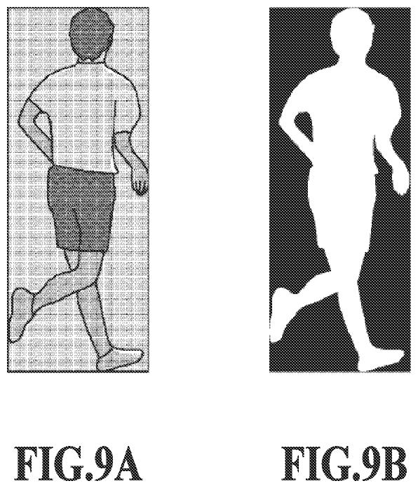

FIGS. 9A and 9B are diagrams illustrating an example of foreground information output from the foreground information generation unit 304. As mentioned earlier, the foreground information contains foreground textures and a foreground mask image. FIG. 9A is a diagram illustrating an example of the foreground textures. FIG. 9B is a diagram illustrating an example of the foreground mask image. The foreground mask image is a binary image with a white region representing a foreground region in a captured image and a black region representing a background region other than the foreground. Using the foreground mask image makes it possible to identify a region in the captured image where a foreground object is present.

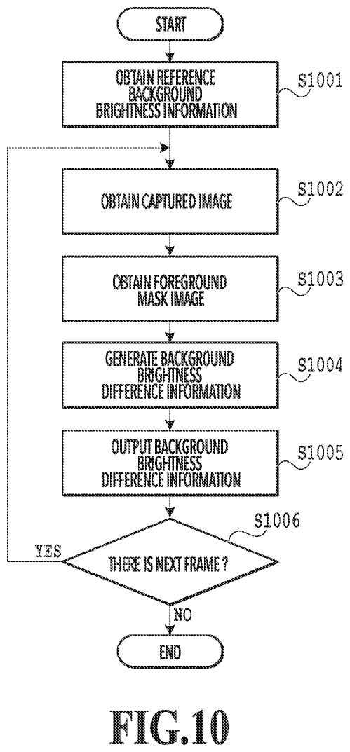

FIG. 10 is a flowchart describing a flow of a process of generating the background brightness difference information in the present embodiment. As with FIG. 5, the flowchart of FIG. 10 illustrates a process performed by one of the image capture processing apparatuses 110a to 110p.

In S1001, which is a similar process to S501, the background brightness difference information generation unit 811 obtains the reference background brightness information managed by the reference background brightness information management unit 305.

In S1002, the background brightness difference information generation unit 811 obtains a captured image of a processing target frame obtained by imaging by the image capture unit 301.

In S1003, the background brightness difference information generation unit 811 obtains a foreground mask image generated from the captured image obtained in S1002.

In S1004, the background brightness difference information generation unit 811 converts the pixel values of the captured image into brightness values. Then, for each pixel, the background brightness difference information generation unit 811 calculates the difference value between the brightness value of the captured image and the brightness value indicated by the reference background brightness information to thereby calculate a brightness difference value of each pixel. Here, the background brightness difference information generation unit 811 sets the brightness difference values in the foreground region indicated in the foreground mask image to “null.” Then, as the brightness difference values of this “null” region, the background brightness difference information generation unit 811 uses the brightness difference values of the corresponding region in the background brightness difference information of the previous frame, for example, to generate background brightness difference information. Nullifying the brightness difference values of the foreground region as above prevents the presence of the foreground from influencing the background brightness difference information. As described above, in the present embodiment, a captured image, reference background brightness information, and a foreground mask image are used to generate background brightness difference information of a processing target frame.

In S1005, which is a similar process to S504, the background brightness difference information generation unit 811 outputs the generated background brightness difference information to the image processing apparatus 130. The processes of S1002 to S1005 are repeated on a frame-by-frame basis.

S1006 is a similar process to S505. If determining that there is a next frame that needs to be processed (YES in S1006), the background brightness difference information generation unit 811 returns to S1002. If determining that there is no next frame (NO in S1006), the background brightness difference information generation unit 811 terminates the processing in this flowchart.

As described above, in accordance with the present embodiment, it is possible to generate background brightness difference information by using a captured image. Thus, it is possible to generate background brightness difference information at the image capture intervals of the image capture unit 301, e.g., 60 frames per second. Accordingly, it is possible to apply the actual brightness, the shadows of structures appearing in the background, and the like to a virtual viewpoint image with only a minor delay.

### Third Embodiment

In the above embodiments, background brightness difference information is described as grayscale bitmap data. In the present embodiment, a method of generating background brightness difference information as information containing position information of a shadow region and a representative value of brightness values will be described.

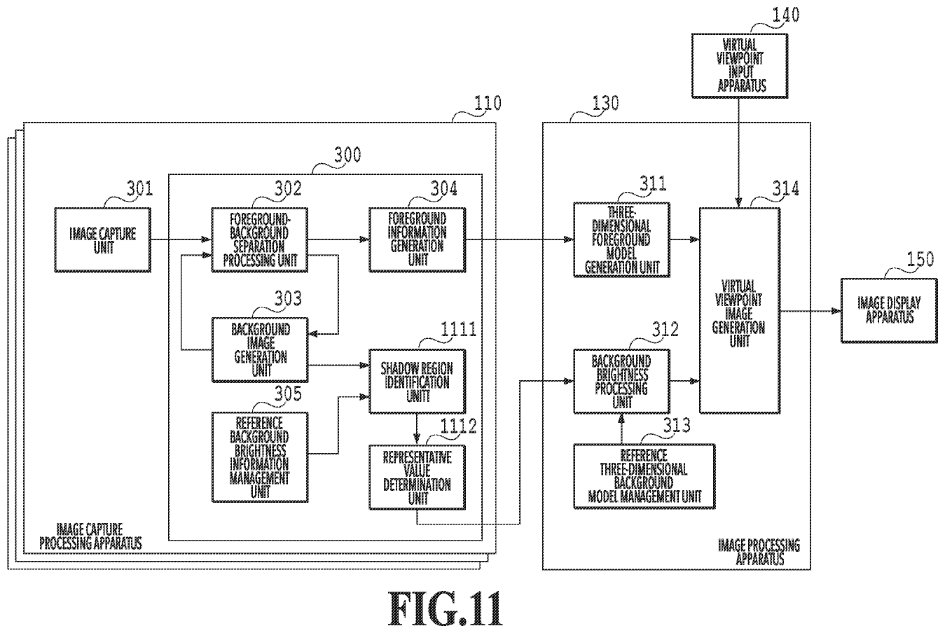

FIG. 11 is a block diagram illustrating a functional configuration of image capture processing apparatuses 110 in the present embodiment. Functional units similar to those in the first embodiment are denoted by the same reference signs, and description thereof is omitted. A shadow region identification unit 1111 uses reference background brightness information output from the reference background brightness information management unit 305 and a background image output from the background image generation unit 303 to identify a shadow region in a captured image or the background image. For example, the shadow region identification unit 1111 identifies a region where the background brightness difference value, which is the difference value between the brightness value of the background image and the brightness value indicated by the reference background brightness information, is less than or equal to a threshold value as a shadow region.

A representative value determination unit 1112 determines a representative value of the background brightness difference values in the shadow region. The representative value determination unit 1112 determines the average or median of the background brightness difference values in the region determined as a shadow region as the representative value. The representative value determination unit 1112 then transmits position information of the shadow region and the representative value to the image processing apparatus 130 as background brightness difference information.

In the present embodiment, in S603 in FIG. 6, the representative values of the shadow region output from the image capture processing apparatuses 110a to 110p are normalized to correct the difference between the representative values.

Also, in S605 in FIG. 6, the background brightness processing unit 312 identifies the shadow region on the reference three-dimensional background model based on the position information of the shadow region contained in the background brightness difference information. Then, the background brightness processing unit 312 increases or decreases the value of luminance of the shadow region on the reference three-dimensional background model by the representative value contained in the background brightness difference information to apply the shadow to the color information of the reference three-dimensional background model.

As described above, in the present embodiment, background brightness difference information is information containing position information of a shadow region and a representative value of background brightness difference values. In this way, it is possible to reduce the amount of data to be transmitted to the image processing apparatus 130.

### Other Embodiments

In the methods described in the above embodiments, each image capture processing apparatus 110 outputs background brightness difference information as is to the image processing apparatus 130. Alternatively, the background brightness difference information generation unit 306 may output background brightness difference information to the image processing apparatus 130 after reducing its data volume by shrinking or compression. The background brightness difference information is, for example, grayscale brightness information, not texture data. Thus, the quality of a virtual viewpoint image is not likely to deteriorate even in a case where the virtual viewpoint image is generated using a three-dimensional background model obtained by applying background difference information which has become coarse due to compression to the reference three-dimensional background model. Accordingly, it is possible to reduce the data volume by shrinking or compressing the background brightness difference information while also reducing influence on the virtual viewpoint image.

In the description of the above embodiments, all image capture processing apparatuses 110a to 110p outputs background brightness difference information, and the image processing apparatus 130 uses these pieces of background brightness difference information from all image capture processing apparatuses 110a to 110p to generate a three-dimensional background model with shadows applied. Also, each of the pieces of background brightness difference information generated by the image capture processing apparatuses 110a to 110p is information on the entire region in the image capture range of the corresponding image capture unit 301. Alternatively, only background brightness difference information that is necessary for applying shadows to a virtual viewpoint image may be output, and the image processing apparatus 130 may use only the background brightness difference information that is necessary for applying shadows to a virtual viewpoint image. This reduces the volume of data to be transmitted.

For example, of the image capture processing apparatuses 110a to 110p, only image capture processing apparatuses that are necessary for generating a virtual viewpoint image may output background brightness difference information or background brightness information to the image processing apparatus 130. For example, only image capture processing apparatuses including image capture units 301 that obtained captured images capturing a foreground may output background brightness difference information or background brightness information to the image processing apparatus 130. Alternatively, the background brightness processing unit 312 of the image processing apparatus 130 may use only the background brightness difference information or background brightness information from some of the image capture processing apparatuses 110a to 110p to apply shadows to the reference three-dimensional background model. Also, the background brightness difference information generated by the image capture processing apparatuses 110a to 110p may be background difference information of a region that is necessary for generating a virtual viewpoint image. For example, the background brightness difference information may be information on the brightness difference values of a region within the image capture range of the image capture unit 301.

In the description of the above embodiments, the image capture processing apparatuses 110a to 110p each perform the process of generating background brightness difference information. Alternatively, the image processing apparatus 130 may perform the process of generating background brightness difference information. Also, the apparatuses that implement the functions of the components illustrated in FIGS. 3, 8, and 11 are not limited. For example, a configuration in which the image processing apparatus 130 has all of the functions of the image processing unit 300 in the image capture processing apparatus 110 may be employed. For example, the image capture processing apparatuses 110a to 110p may output background brightness information, which is information on the brightness values of a captured image or information on the brightness values of a background image, to the image processing apparatus 130. Then, the image processing apparatus 130 may correct the color information of the reference three-dimensional background model based on the information on the brightness values of the captured image or the information on the brightness values of the background image. For example, the image processing apparatus 130 may generate background brightness difference information based on the information on the brightness values of the captured image or the information on the brightness values of the background image and apply the generated background brightness difference information to the color information of the reference three-dimensional background model to correct the color information.

In accordance with technology of the present disclosure, it is possible to reduce the burden for generating a proper virtual viewpoint image.

An object of the present disclosure can be achieved by, for example, supplying a storage medium in which is recorded the code of a computer program that implements the above-described functions to a system and causing the system to read out and execute the code of the computer program. In this case, the code of the computer program read out of the storage medium implements the functions in any of the above-described embodiments, and the storage medium storing the code of the computer program serves as a component of the technology of the present disclosure. Also, the present disclosure includes a case where the operating system (OS) running on a computer or the like performs some or all of the actual processes by following instructions in the code of the program, and those processes implement the above-described functions.

The object of the present disclosure may also be implemented as follows. Computer program code read out of a storage medium is written to a memory included in a function expansion card inserted in a computer or a function expansion unit connected to a computer. Then, a CPU included in the function expansion card or the function expansion unit or the like performs some or all of actual processes by following instructions in the computer program code to implement the above-described functions.

In the case of applying the technology of the present disclosure to the above storage medium, the storage medium stores the computer program code corresponding to the flowcharts described earlier.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-037503 filed Mar. 10, 2023, which are hereby incorporated by reference wherein in their entirety.

What is claimed is:

1. An image processing apparatus comprising:
one or more memories storing instructions; and
one or more processors executing the instructions to:
obtain information on a brightness value of a captured image captured by an image capture apparatus for generating a foreground image or of a background image generated from the captured image;
correct color information of three-dimensional shape data of a background based on the brightness value; and
generate a virtual viewpoint image by using the three-dimensional shape data colored with the corrected color information.

2. The image processing apparatus according to claim 1, wherein
difference information indicating a difference value between the brightness value of the captured image or the background image and a brightness value of a region in the three-dimensional shape data, the region corresponding to an image capture range of the image capture apparatus, is obtained as the information on the brightness value, and
the color information of the three-dimensional shape data is corrected by applying the difference information to the color information.

3. The image processing apparatus according to claim 1, wherein the information on the brightness value is obtained for each image capture apparatus which captures an image of a foreground among a plurality of image capture apparatuses.

4. The image processing apparatus according to claim 1, wherein
the generated virtual viewpoint image is a virtual viewpoint image with a shadow in the background, and
the virtual viewpoint image with the shadow in the background is generated using the three-dimensional shape data colored with the corrected color information.

5. The image processing apparatus according to claim 1, wherein the color information before the correction is information on a color of the background in a state with no shadow.

6. The image processing apparatus according to claim 2, wherein the brightness value in the three-dimensional shape data is a brightness value of the background in a state with no shadow.

7. The image processing apparatus according to claim 1, wherein the background image is an image obtained by updating a pixel value of a region of the background in an image generated in advance with a pixel value of the region of the background in the captured image.

8. The image processing apparatus according to claim 1, wherein the background image is an image to be used in a process of separating a background region and a foreground region from the captured image.

9. The image processing apparatus according to claim 2, wherein the difference information is information containing position information of a shadow region in the captured image or the background image and a representative value of the difference value in the shadow region.

10. The image processing apparatus according to claim 2, wherein the difference information is bitmap data in which a pixel value of each pixel thereof indicates the difference value.

11. The image processing apparatus according to claim 2, wherein the difference information in a compressed state is obtained as the information on the brightness value.

12. The image processing apparatus according to claim 1, wherein the image capture apparatus is one of a plurality of image capture apparatuses that capture images in synchronization with each other.

13. The image processing apparatus according to claim 10, wherein the difference information is information indicating the difference value of a pixel in a region within the image capture range.

14. The image processing apparatus according to claim 1, wherein the brightness value is a gray value on a grayscale.

15. The image processing apparatus according to claim 2, wherein the one or more processors execute the instructions to further execute
obtain the captured image captured by the image capture apparatus or the background image generated from the captured image;
manage the brightness value of the region in the three-dimensional shape data of the background; and
generate the difference information indicating the difference value between the brightness value of the captured image or the background image and the managed brightness value of the region.

16. An image processing method comprising:
obtaining information on a brightness value of a captured image captured by an image capture apparatus for generating a foreground image or of a background image generated from the captured image;
correcting color information of three-dimensional shape data of a background based on the brightness value; and
generating a virtual viewpoint image by using the three-dimensional shape data colored with the corrected color information.

17. A non-transitory computer readable storage medium storing a program which causes a computer to perform an image processing method, the image processing method comprising:
obtaining information on a brightness value of a captured image captured by an image capture apparatus for generating a foreground image or of a background image generated from the captured image;
correcting color information of three-dimensional shape data of a background based on the brightness value; and
generating a virtual viewpoint image by using the three-dimensional shape data colored with the corrected color information.
